(19) United States
(12) Patent Application Publication
(10) Pub. No.: US 2021/0097323 A1
(43) Pub. Date: Apr. 1, 2021

(54) METHOD AND APPARATUS FOR REAL-TIME TEXT REPLACEMENT IN A NATURAL SCENE

(71) Applicant: KONICA MINOLTA BUSINESS SOLUTIONS U.S.A., INC., San Mateo, CA (US)

(72) Inventors: Junchao WEI, San Mateo, CA (US); Wei MING, Cupertino, CA (US); Xiaonong ZHAN, Foster City, CA (US)

(73) Assignee: KONICA MINOLTA BUSINESS SOLUTIONS U.S.A., INC., San Mateo, CA (US)

(21) Appl. No.: 16/585,604

(22) Filed: Sep. 27, 2019

(51) Int. Cl. G06K 9/32; G06T 7/73; G06K 9/34; G06T 19/00

(52) U.S. Cl. CPC G06K 9/3258; G06T 7/73; G06K 2209/01; G06T 19/006; G06K 9/344

(57) ABSTRACT

In augmented reality (AR) and mixed reality (MR) representations of natural scenes that includes text on different kinds of surfaces, real-time text replacement facilitates user involvement with and appreciation of the natural scenes. Determination of surface curvature using a three-dimensional (3D) camera enables determination of consequent textual distortion and necessary compensation in order to read text accurately. Translation, transliteration, or other modification of text and replacement with that text in a natural scene enables a user to participate more fully in the scene.

### BACKGROUND OF THE INVENTION

There are number of three-dimensional (3D) camera applications for Augmented Reality (AR) and Mixed Reality (MR) products. In these products, it is becoming more desirable to be able to modify digital content in real time for different users. One example of such digital content is text that occurs in natural scenes.

Natural scene text can appear in a variety of ways (e.g. billboards, product labels, signs), and can contain a variety of information, from commercials, to container contents, to directions and locations, to building or location identification, among others. In AR and MR situations, users may focus promptly on such information, to see if it is helpful or can be used for the scenario(s) in which the users are participating. However, merely adding information can be difficult and confusing for users.

It would be desirable to provide natural scene text in a manner that is easy for users to assimilate.

### SUMMARY OF THE INVENTION

Aspects of the invention manipulate and replace the text contents in a natural scene without disrupting the scene. As an example, according to an embodiment a three-dimensional (3D) camera may pick up information on an irregular surface (in an embodiment, a curved surface). An Optical Character Recognition (OCR) engine may capture text from that information and digitize the text, for later translation, transliteration, or conversion into another digital form, for example, in a different language. When the converted or translated text is substituted for the existing text in the natural scene, a user can have a more natural real time experience.

### BRIEF DESCRIPTION OF THE DRAWINGS

FIG. 1 is an overall flowchart depicting operation of the inventive method and apparatus according to an embodiment.

FIG. 2 is a flowchart depicting operation of aspects of the operations shown in FIG. 1.

FIGS. 3A and 3B are conceptual diagrams showing the identification of text on a 3D surface according to an embodiment.

FIGS. 4A and 4B are diagrams depicting coordinate mapping of text on a 3D surface according to an embodiment.

FIG. 5 is a conceptual diagram showing mapping of text on a 3D surface according to an embodiment.

FIGS. 6A and 6B are diagrams showing additional detail for coordinate mapping of text and background on a 3D surface according to an embodiment.

FIGS. 7A and 7B are diagrams showing more detail for coordinate mapping of text and background on a 3D surface according to an embodiment

FIG. 8 is a diagram depicting combining of text and background information for placement on a 3D surface according to an embodiment.

FIG. 9 is a high level block diagram depicting apparatus according to an embodiment.

### DESCRIPTION OF EMBODIMENTS

Embodiments of the present invention provide a practical application in computer-based imaging, particularly AR and MR, by providing real-time substitution of text in a form that a user can work with, understand, and/or assimilate more easily.

In most AR/MR applications, the contents from a natural scene are often mixed or combined with inputting contents. In accordance with aspects of the invention, 3D imaging retains the original view in an AR/MR environment, and provides data such as text from a curved surface. That text is transformed from the curved surface to generate linear text. Translation or transliteration of the data leads to substitution of the generated linear text with corresponding text, for example, in another language or alphabet. Substitution of the text in real time in an AR/MR environment enhances the user experience by enabling the user to comprehend and assimilate the substituted text. It would be as if, for example, an American were walking through the streets of Tokyo and encountering various irregular objects, such as rounded signs, cans or other round or irregularly-shaped containers, the original text on those objects were translated or transliterated, and the original text replaced in situ. The person walking the streets would be able to read and understand the replacement text.

In one aspect, using 3D camera sensing techniques helps to retain the original view, including background for any text that is to be replaced, and provide the same background and context for the replacement text as for the original text. Several key factors may be considered. First, the perspective, i.e. the viewing angle of looking at the object, informs how the digital contents (replacement text, in an embodiment) should be placed to align with the viewing angle that the human eye sees. Second, the size of the replacement contents should fit into the area of the curved or irregular surface in the same way, perhaps taking up the same or a similar amount of space, as the original contents. Third, when the replacement contents are provided to replace the original contents, the background color and shading should be retained, and filled in or removed as appropriate, to provide a consistent background. Fourth, the real-time implementation of the technique to process original content and replace it should be cost effective.

According to an embodiment, a 3D camera scans a nonparametric surface to acquire 3D information, for example, as a dense point cloud. This 3D information can be used to reconstruct a 3D surface. The 3D information includes information about surface curvature and normals to the surface. This information can be used to estimate the position and orientation of original text. To place new text onto the nonparametric surface, the original text and the replacement text are mapped using parameterized points. For example, for text on a surface of a bottle, the text may be mapped on a regional basis, so that the text characters can be handled individually to be mapped. The regions are matched up according to curvature, to enable smooth mapping of the text. Finally, to preserve the background and merge the new text with the scene, image inpainting may be used to recover the background of the original text so that the new text appears over the background in the same way that the original text did. For example, if the original text appears black on a blue background, the new text also will appear as black on a blue background, without other colors being interposed.

In one aspect, processing in accordance with an embodiment handles various kinds of objects in an AR/MR environment, including such irregularly shaped objects as bottles, cups, cans, handbags, sporting equipment, and others. Techniques according to aspects of the invention also handle various geometric shapes, including cylinders, cones, and spheres, as well as flat surfaces. A 3D camera provides both color image information and geometric information. Where surface curvature results in variations in appearance of text, those textual variations can be computed and then can be applied to determine positioning of replacement text, so the replacement text can follow the same variations as did the original text, yielding a correspondingly smooth view. In one aspect, a 3D camera may provide a fast scanning rate, enabling real-time application and processing.

As ordinarily skilled artisans will appreciate, the mapping and replacement techniques described herein mapping of text for regular and curved surfaces. Rather, the techniques are applicable wherever it may be desirable to replace one type of information for another on a designated surface in a natural scene, whether the surface in question is planar, curved, or otherwise non-parametric. Examples include not only the AR/MR context discussed herein, but also commercials, educational videos, fashion design, and gaming, as well as interactive 3D modeling.

In the following discussion, various terminology may be used to identify the text that is being detected on a non-parametric surface, and the text that is to replace the detected text. The detected text may be referred to as original text. The text that replaces the detected text may be referred to as replacement text, new text, or candidate text. The use of different terminology where it appears in this context in no way is intended to imply differing meaning or status of the original text and the text that replaces it.

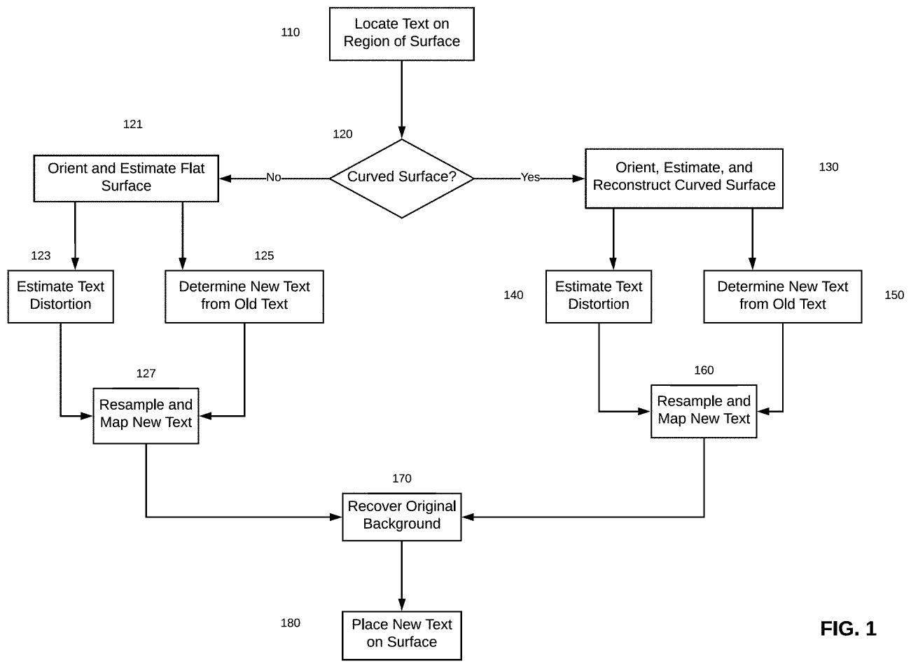

FIG. 1 depicts an overall flow according to an embodiment, beginning with text detection. Text detection may be implemented in various ways, using one form of computer vision or another. In one embodiment, a deep learning model may be implemented to facilitate text detection. Particularly where a scene is complicated, and text detection may be more difficult because of the background, a deep learning model that is trained to handle such complications may enable text detection to be carried out more easily.

Looking at FIG. 1, at 110, original text is detected or located on a surface. At 120, a determination is made whether the surface is curved or otherwise non-parametric. Image processing techniques to identify non-parametric surfaces are well known to ordinarily skilled artisans. If the surface is not curved or otherwise nonparametric, then at 121 the surface is evaluated, oriented, and estimated as a flat surface. At 123, the located original text is evaluated to estimate an amount of distortion that might occur, for example, if the flat surface is at an angle rather than full on. As part of this evaluation, an orientation of the surface is estimated and compensated using various techniques, including but not limited to translation, rotation, scaling, and shearing. At 125, the located original text is processed as appropriate, for example, translated from one language to another, or transliterated from one alphabet to another, so that at 127, a new text block may be formed, and shaped or reshaped as appropriate to match up with the shape of the original text.

If the surface is curved or otherwise non-parametric, then at 130 the surface is evaluated, oriented, and estimated as a curved or otherwise non-parametric surface. At 140, distortion resulting from the location of text on a non-parametric surface is estimated and compensated using the above-mentioned techniques, to enable or otherwise facilitate the identification of that text. At 150, once the text is determined, new text, for example, a translation of the original text into a different language, or transliteration into a different alphabet, is determined. At 160, that new text may be resampled, and mapped, for example, into a space that has similar dimensions to the space in which the original text was located.

Whether the surface is planar, curved, or otherwise non-parametric, compensation for distortion is desirable to facilitate translation or transliteration.

Whether the new text is to be located on a flat surface or a non-parametric surface, the background in which the original text appeared has to be evaluated and recovered in order to provide a smooth appearance for the new text, without discoloration or variation in coloration of the background. This background recovery occurs at 170. Once that is accomplished, at 180 the new text, with the appropriate background, may be located on the surface.

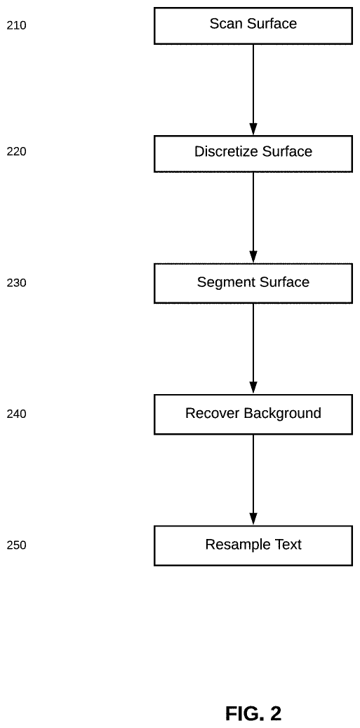

FIG. 2 shows an exemplary flow of operation for the orientation, estimation, and reconstruction of the curved or otherwise non-parametric surface (130 in FIG. 1). At 210, the surface is scanned, to acquire geometrical data with RGB (color) data as well as the text to be modified (old text or target text). At 220, the scanned surface is discretized by being broken up into distinct parts. At 230, those distinct parts are treated as segments, to facilitate creation of a mapping of segments between old or target text, on the one hand, and candidate text, on the other. At 240, the background of the surface is identified, and is filled out so that when the new text is placed on that background, there are no inconsistencies or missing pieces of background. One technique for filling out the background is image inpainting, which recovers the target text background for the placement of the candidate text. At 250, once the surface has been discretized and segmented, text may be resampled to get a more accurate rendering of the text, thereby facilitating accurate replacement of that text with new text.

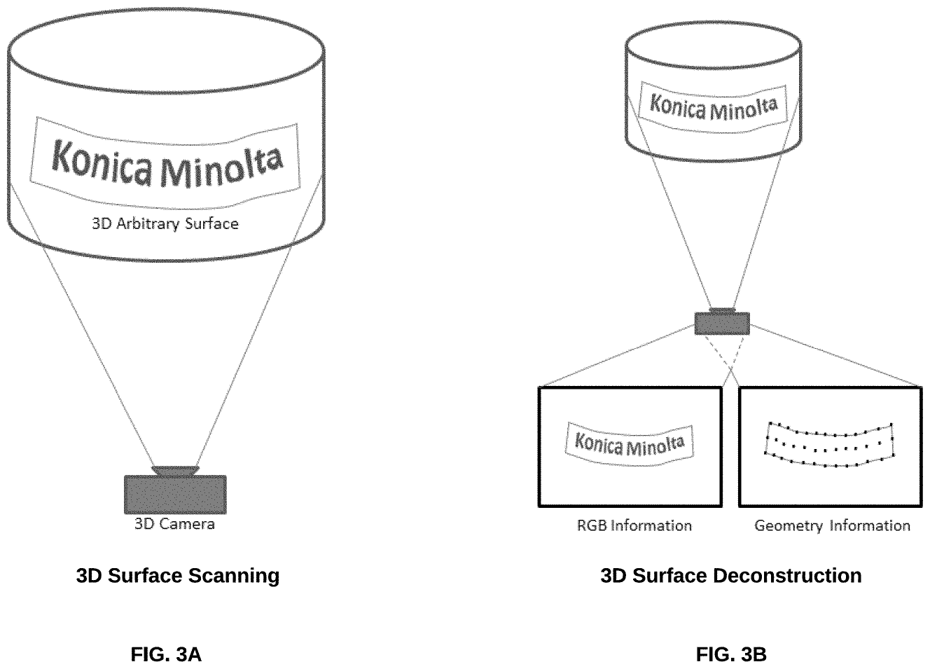

The surface model can be evaluated and established using a 3D camera to perform 3D scanning, which can acquire both surface color texture data and geometry data. FIG. 3A shows a curved company logo tag on a rough cylindrical surface, with some amount of distortion over the region where the tag appears. FIG. 3A also shows the scanning configuration of the 3D camera. The 3D camera may scan the surface to find and locate target text. It should be noted that the logo tag is depicted for convenience as occupying a portion of the curved surface which is visible from a single side. It may be that the logo tag could substantially or entirely encircle the surface. For ease of description, FIG. 3A shows scanning of only a portion of the overall surface.

The 3D scanning may need to be repeated to generate multiple data sets, in order to get accurate surface data. The multiple data sets may be processed using various kinds of interpolation routines.

3D scanning identifies two types of data: (1) RGB data; and (2) Geometric data. FIG. 3B shows the deconstruction of the scanned data into RGB information and geometric information.

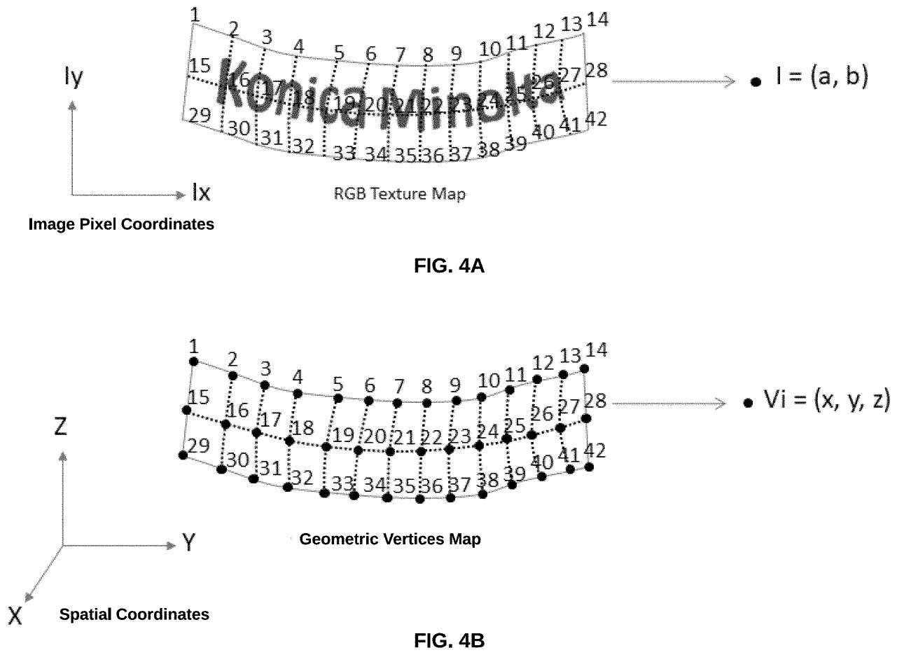

FIG. 4A and 4B depict the RGB color information and the geometric information, respectively. Looking at FIG. 4A, the logo is divided into pieces as defined by segments. Merely by way of example, in FIG. 4A there are 26 segments, 13 above and 13 below. Points 1-14 define the upper boundaries of the upper segments, and points 15-28 define the lower boundaries. Correspondingly, points 15-28 define the upper boundaries of the lower segments, and points 29-42 the lower boundaries. FIG. 4A shows texture data containing RGB color information, for storage as 2D image coordinates Iᵢ=(a, b). FIG. 4B shows geometric data containing spatial information, for storage as 3D coordinates Vᵢ=(x, y, z).

The segments in FIGS. 4A and 4B, and in other Figures as discussed herein, are shown as being four-sided, appearing as rectangles, trapezoids, rhombi, or other quadrilaterals, even four-sided shapes with curved sides, as would be expected on a curved surface. Depending on the type of surface, the segments may have a different number of sides.

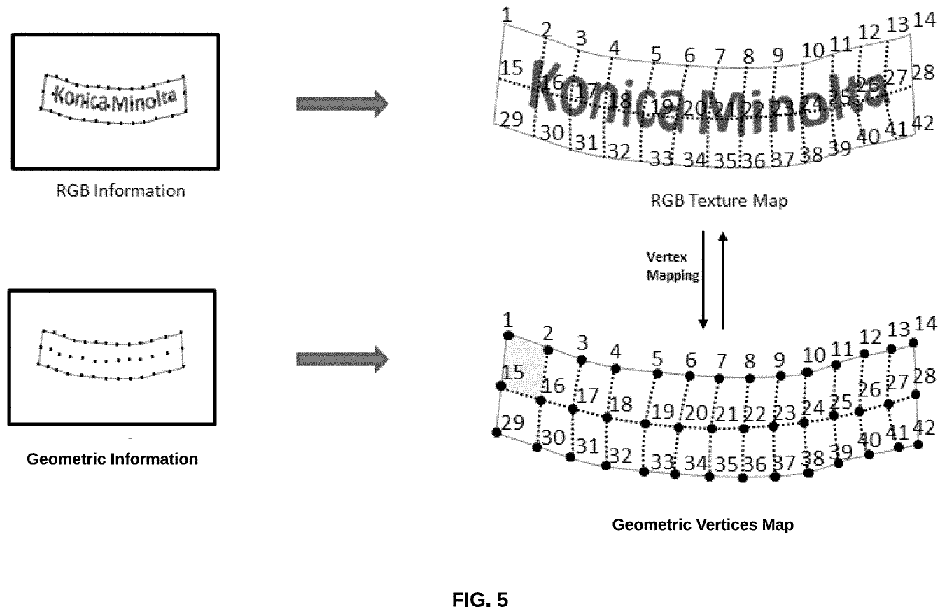

In FIG. 5, the surface model of the deconstructed data in FIG. 3B is processed separately. In an upper portion of FIG. 5, the RGB information is plotted onto a texture map using the vertices discussed with respect to FIGS. 4A and 4B. In a lower portion of FIG. 5, the geometric information is plotted onto a similar map using those vertices. In one aspect, the greater the detected curvature, the larger the number of segments. In this circumstance, a larger number of segments is necessary in order to provide an accurate mapping of the data to identify the text.

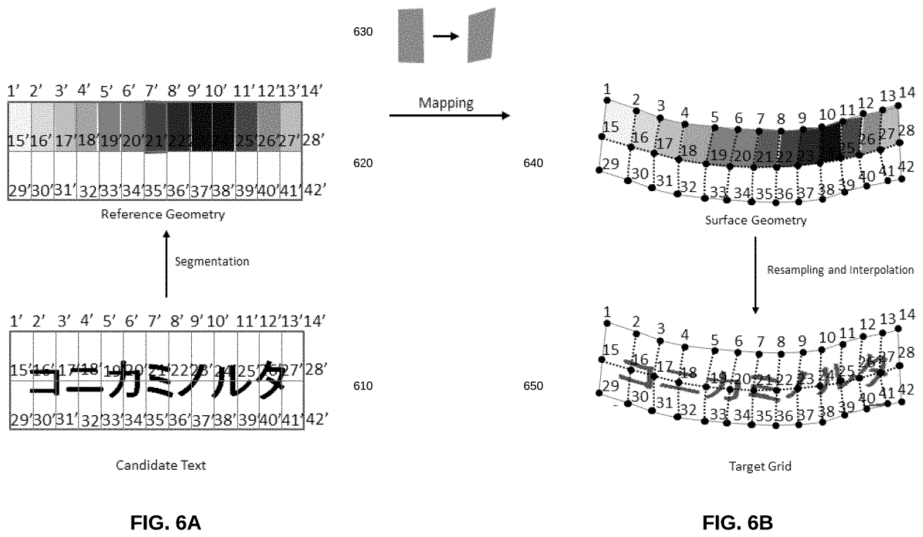

FIGS. 6A and 6B show mapping of candidate replacement text where original text was located. At 610, candidate text is segmented, and placed in a reference geometry at 620. Because characters in the candidate text are planar, the reference geometry is planar. A mapping 630 enables mapping of the reference geometry 620 to the actual surface geometry 640. With resampling and interpolation or other suitable location techniques, at 650 the candidate text is mapped to a target grid which represents the surface from which the original text was taken, and to which the candidate text is to be applied.

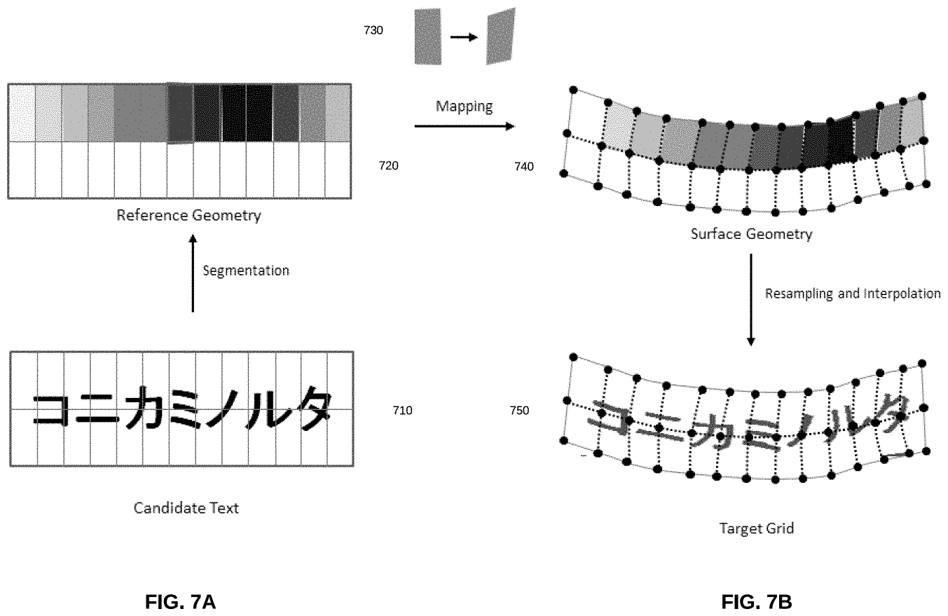

FIGS. 6A and 6B show various coordinate points which are mapped to set out the grid for placement of the candidate text. FIGS. 7A and 7B correspond to FIGS. 6A and 6B, but omit the coordinate points, so that it is easier to see the sequence of mapping of the candidate text to the target grid representing the surface to which the candidate text is to be applied.

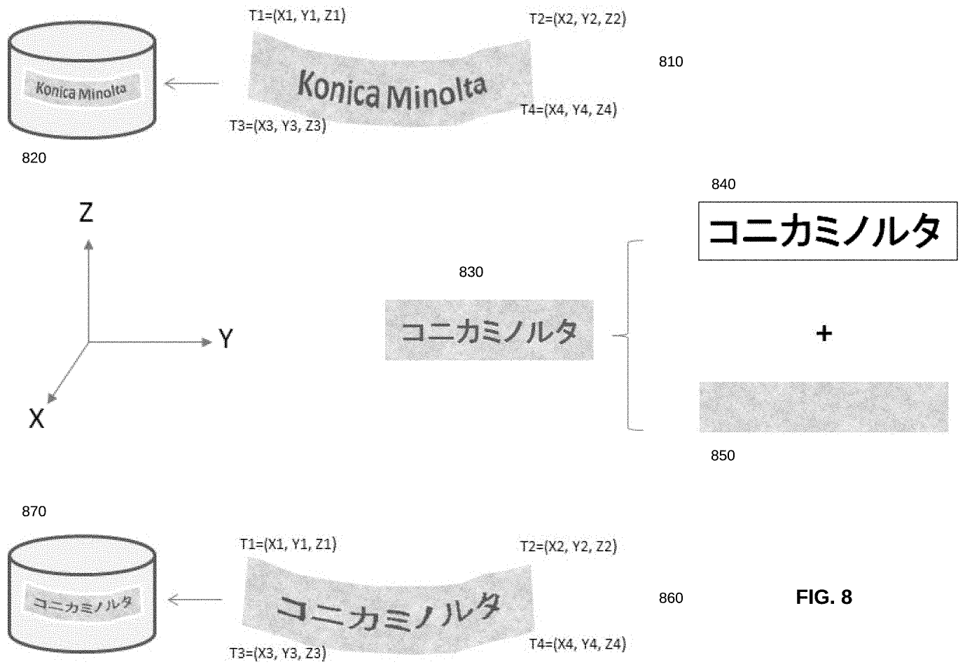

FIG. 8 shows how the new text (in this example, Japanese text) replaces original text (I this example, English text) on a curved surface. At 810, there is a mapping of the coordinates of the endpoints of the background to be manipulated. At 820, the words “KonicaMinolta” are located on a background. 830 shows the replacement text as a combination of text 840 and background 850. In an embodiment, once the replacement text is determined, that text can be mapped to the background according to the mapping done at 820. In one aspect, the background can be filled in using an image inpainting technique so that the new text appears over the background, without differently-colored spaces suggesting deletion and insertion of text. Mapping shown at 860 mirrors the mapping done at 820 so that the replacement text appears naturally in place of the original text. At 870, the replacement text, with the appropriate background, is located on the curved surface in accordance with the mapping done at 870.

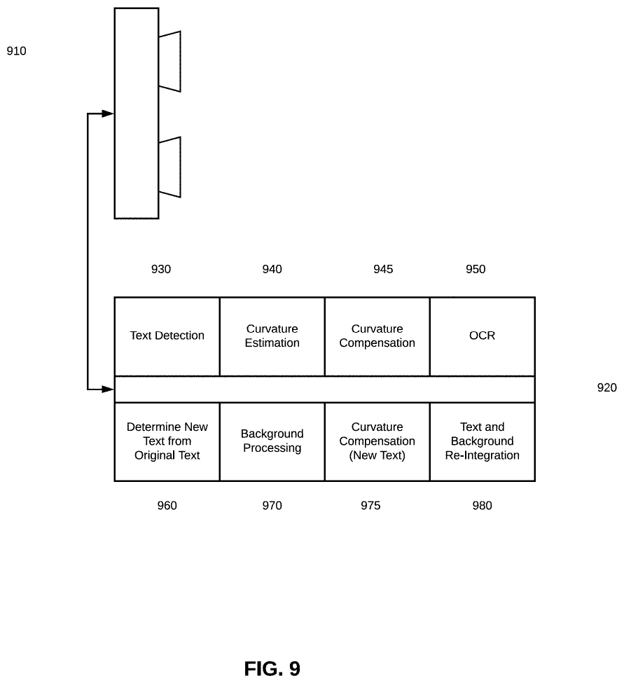

FIG. 9 depicts a system in which a 3D camera 910 provides data to a processing system 920. Within the processing system 920 there are blocks to handle the various tasks. A block 930 manages location of text from the data that the 3D camera 910 provides. A block 940 estimates curvature of a surface on which the located text appears. Curvature estimation may aid in the reading of the located text so that the located text is intelligible. A block 945 may compensate for the curvature to facilitate detection of the text. An OCR block 950 manages the reading of detected text. A block 960 may translate, transliterate, or otherwise determine new or modified text from the detected original text. A block 970 may process a background on which original text appears, so that when the new or modified text is placed where the original text was, the background and new/modified text appear seamless. Block 975 takes the new or modified text and adapts it to fit the curvature of the surface on which the text is to be placed. Block 980 provides processing to accomplish seamless re-integration of the new text with the background.

While several particular forms of the invention have been illustrated and described, it will also be apparent that various modifications may be made without departing from the scope of the invention. It is also contemplated that various combinations or subcombinations of the specific features and aspects of the disclosed embodiments may be combined with or substituted for one another in order to form varying modes of the invention. Accordingly, it is not intended that the invention be limited, except as by the appended claims.

1. A method comprising:
locating original text on a surface within a scene;
responsive to a determination that the surface is a curved surface, compensating for surface curvature;
responsive to the compensating, identifying the original text;
producing modified text from the original text; and
using the surface curvature, replacing the original text with the modified text on the curved surface within the scene.

2. The method of claim 1, wherein the compensating comprises:
orienting, estimating, and reconstructing the curved surface; and
estimating an amount of distortion in the original text resulting from the surface curvature.

3. The method of claim 1, wherein the scene is an augmented reality (AR) or mixed reality (MR) depiction of the scene, and wherein the user experiences the scene as the user moves through the scene.

4. The method of claim 1, wherein producing the modified text comprises one of transliterating or translating the original text.

5. The method of claim 1, wherein the locating and examining comprises scanning the surface with a three-dimensional (3D) camera, and wherein an output of the 3D camera enables the determination that the surface is curved.

6. The method of claim 2, wherein the estimating comprises discretizing the curved surface into a plurality of segments to identify coordinates for the segments, the method further comprising mapping the segments of the curved surface to a planar surface to map the original text to the planar surface as mapped original text.

7. The method of claim 6, wherein the identifying comprises performing optical character recognition (OCR) on the mapped original text.

8. The method of claim 7, wherein the producing comprises one of:
translating the mapped original text into a different language; or . transliterating the mapped original text into a different alphabet.

9. The method of claim 8, wherein the replacing comprises mapping the modified text onto the curved surface as mapped modified text.

10. The method of claim 8, further comprising:
determining an original background of the original text within the scene; and
producing a modified background and superimposing the modified text on the modified background so that the modified text and the modified background appear without any gaps between the modified background and the modified text.

11. The method of claim 10, further comprising mapping the modified text and modified background on the curved surface as a replacement for the original text and original background.

12. The method of claim 1, wherein the curved surface appears on an object within the scene.

13. The method of claim 1, wherein the replacing occurs in real time, as a user experiences the scene.

14. Computer-implemented apparatus which executes software which, when implemented, performs a computer-implemented method comprising:
locating original text on a surface within a scene;
responsive to a determination that the surface is a curved surface, compensating for surface curvature;
identifying the original text;
producing modified text from the original text; and
replacing the original text with the modified text on the curved surface within the scene.

15. The apparatus of claim 14, wherein the compensating comprises:
orienting, estimating, and reconstructing the curved surface; and
eliminating distortion in the original text resulting from the surface curvature.

16. The apparatus of claim 14, wherein the scene is an augmented reality (AR) or mixed reality (MR) depiction of the scene, and wherein the user experiences the scene as the user moves through the scene.

17. The apparatus of claim 14, wherein producing the modified text comprises one of transliterating or translating the original text.

18. The apparatus of claim 14, further comprising a three-dimensional (3D) camera to scan the surface, and wherein an output of the 3D camera enables the determination that the surface is curved.

19. The apparatus of claim 15, wherein the estimating comprises discretizing the curved surface into a plurality of segments to identify coordinates for the segments, the method further comprising mapping the segments of the curved surface to a planar surface to map the original text to the planar surface as mapped original text.

20. The apparatus of claim 19, wherein the identifying comprises performing optical character recognition (OCR) on the mapped original text.

21. The apparatus of claim 20, wherein the producing comprises one of:
translating the mapped original text into a different language; or .
transliterating the mapped original text into a different alphabet.

22. The apparatus of claim 21, wherein the replacing comprises mapping the modified text onto the curved surface as mapped modified text.

23. The apparatus of claim 21, wherein the computer-implemented method further comprises:
determining an original background of the original text within the scene; and
producing a modified background and superimposing the modified text on the modified background so that the modified text and the modified background appear without any gaps between the modified background and the modified text.

24. The apparatus of claim 23, wherein the computer-implemented method further comprises mapping the modified text and modified background on the curved surface as a replacement for the original text and original background.

25. The apparatus of claim 14, wherein the curved surface appears on an object within the scene.

26. The apparatus of claim 14, wherein the replacing occurs in real time, as a user experiences the scene.
